(19) United States
(12) Patent Application Publication
(10) Pub. No.: US 2010/0069801 A1
(43) Pub. Date: Mar. 18, 2010

(54) ROWING MASSAGE MACHINE

(76) Inventor: Cheng-Ta TSAI, Taipei (TW)

Correspondence Address: PATENTTM.US, P. O. BOX 82788, PORTLAND, OR, 97282-0788, US

(21) Appl. No.: 12/211,623

(22) Filed: Sep. 16, 2008

(51) Int. Cl. A61H 7/00; A63B 69/06

(52) U.S. Cl. 601/134; 601/84; 482/72

(57) ABSTRACT

The rowing massage machine has a base frame, a footrest, a rowing mechanism and a massage device. The base frame has a base. The footrest is mounted on a front end of the base. The rowing mechanism is mounted on the base and has a chair and at least one rowing resilient element. The chair has a seat and a backrest having longitudinal slits. The rowing resilient element is mounted between the footrest and the rowing mechanism. The massage device has four body massaging wheels and at least one massaging resilient element. The massaging rolling wheels are rotatably mounted on rods connected to the base and are respectively mounted through the slits of the chair. The massaging resilient element is mounted between the rowing mechanism and the massage device. When an operator sits on the chair to exercise, he/her receives a foot, back and upper leg massage.

### BACKGROUND OF THE INVENTION

1. Field of the Invention

The present invention relates to a rowing massage machine, especially to be a rowing massage machine that has a massage function.

2. Description of the Prior Arts

Working out is a popular way to stay healthy and relax. However, some people do not have access to gym due to a variety of reasons including: location, self-confidence, cost or time so may buy a personal or home-use exercise machine. A multi-purpose exercise machine has been provided in the prior art, but each mode requires transforming the machine that requires time, space and effort, so many people use only one mode. Therefore, people require a multi-muscle targeting exercise machine. Furthermore, home-use exercise machines are for busy people who wish to relax during exercise.

To overcome the shortcomings, the present invention provides a rowing massage machine to mitigate or obviate the aforementioned problems.

### SUMMARY OF THE INVENTION

The main objective of the present invention is to provide a rowing massage machine having massage function.

The rowing massage machine in accordance with the present invention has a base frame, a footrest, a rowing mechanism and a massage device. The footrest is formed on the front end of the base frame. The base frame has a base. The rowing mechanism is mounted on the base and has a chair and at least one rowing resilient element. The chair has a seat and a backrest having longitudinal slits. The rowing resilient element is mounted between the footrest and the rowing mechanism. The massage device has four body massaging wheels and at least one massaging resilient element. The massaging rolling wheels are rotatably mounted on rods connected to the base and are respectively mounted through the slits. When an operator sits on the chair to exercise, he/her receives a foot, back and upper leg massage.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a rowing massage machine in accordance with the present invention;

FIG. 2 is an enlarged perspective view of the rowing massage machine in FIG. 1, wherein a seat thereof being shown in phantom lines;

FIG. 3 is an operational side view of the rowing massage machine in FIG. 1, showing an operator seated; and

FIG. 4 is an operational side view of the rowing massage machine in FIG. 1, showing the operator lying.

### DETAILED DESCRIPTION OF THE PREFERRED EMBODIMENTS

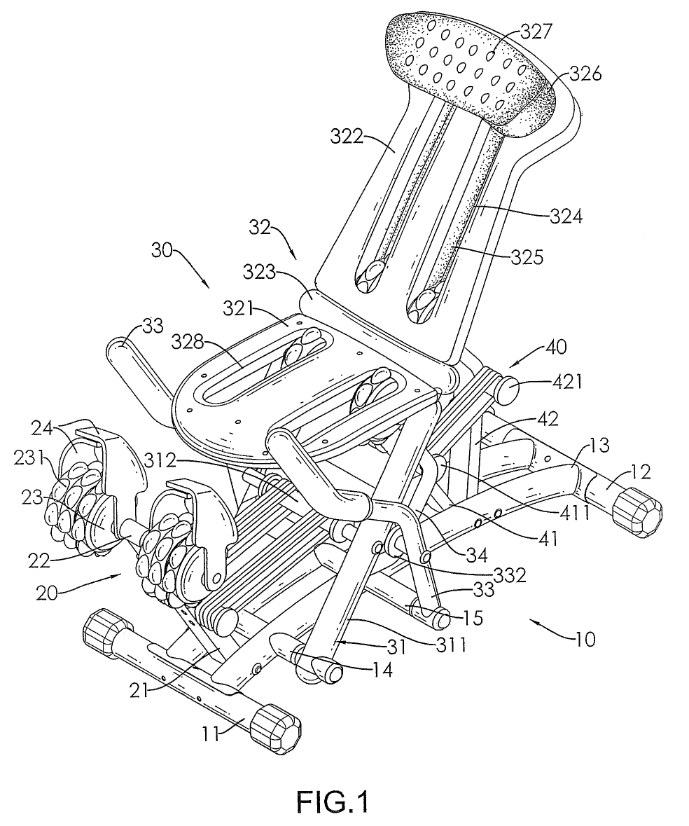

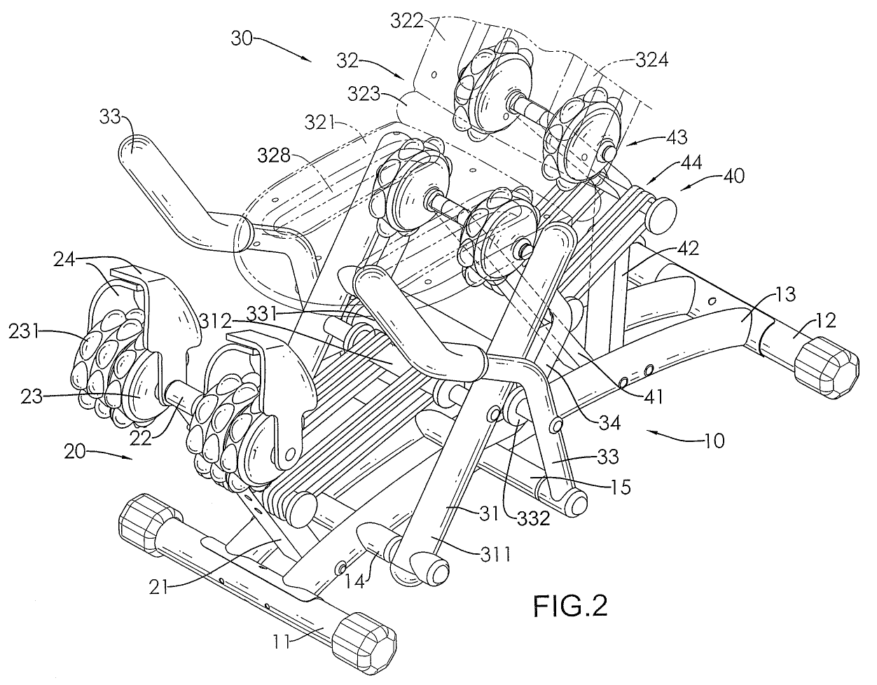

With reference to FIGS. 1 and 2, a rowing massage machine in accordance with the present invention has a base frame (10), a footrest (20), a rowing mechanism (30) and a massage device (40).

The base frame (10) has abase (13), two supporting legs (11, 12), a front connection rod (14) and a rear connection rod (15).

The base (13) has a front end and a rear end and may comprise multiple longitudinal rods.

The supporting legs (11, 12) are respectively attached to the front and rear ends of the base (13), may be mounted transversely on the ends of the longitudinal rods and may have ends having non-slip feet mounted thereon.

The front connection rod (14) is mounted transversely through the base (13) and is adjacent to one supporting leg (11) and has two ends.

The rear connection rod (15) is intermediately mounted transversely through the base (13) and has two ends.

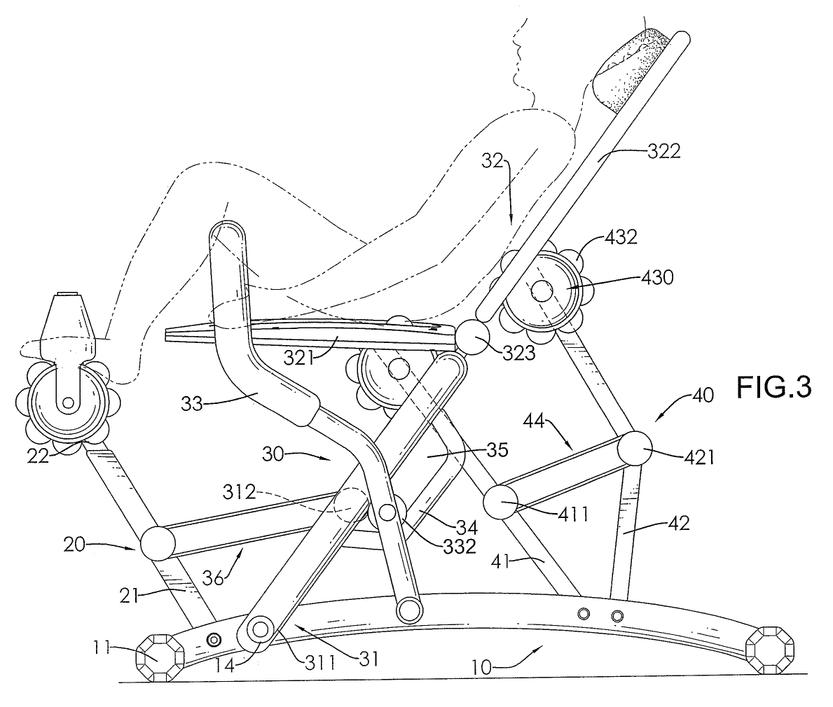

With further reference to FIG. 3, the footrest (20) is mounted on the front end of the base (13) and has a strut (21), a foot support (22), two foot massaging wheels (23) and two foot-straps (24).

The strut (21) is mounted on the base (13) between the supporting leg (11) at the front end of the base (13), may be mounted between two longitudinal rods and has a distal end.

The foot support (22) is mounted on the distal end of the strut (21), may be extensibly mounted in the strut (21) and has two arms protruding transversely therefrom.

The foot massaging wheels (23) are respectively mounted rotatably on the arms of the foot support (22) and each has an annular surface and multiple massage protrusions (231). The massage protrusions (231) are formed on the annular surface of the foot massaging wheel (23).

The foot-straps (24) are respectively mounted adjacent to the massaging wheels (23) and may be mounted respectively on the arms of the foot support (22) and each foot-strap (24) may be an elastic strap or two inelastic straps being adjustably connected and using hook and loop connectors, a buckle, clip or the like. Preferably, each foot strap (24) is implemented as two inelastic straps being adjustably connected and using hook and loop connectors.

The rowing mechanism (30) is mounted on the base frame (10) and has a pivoting frame (31), at least one rowing resilient element (36), a chair (32) and two handles (33).

The pivoting frame (31) has two pivoting rods (311), a driven rod (312) and two guide rails (34). The pivoting rods (311) are mounted pivotally on the base (13) and each pivot rod (311) has a frame end and a chair end. The frame ends are respectively mounted movably on the ends of the front connection rod (14). The driven rod (312) is mounted between the pivoting rods (311). The guide rails (34) are U-shaped and are respectively formed on the pivoting rods (311) to form a guide slot (35) in the pivoting frame (31).

The at least one resilient element (36) is mounted between the driven rod (312) and the footrest (20), may be mounted on the strut (21) of the footrest to provide resistance by allowing the pivoting frame (31) to move from an original position away from the strut (21) and automatically return to the original position.

The chair (32) is mounted on the pivoting frame (31) and has a connector (323), a seat (321) and a backrest (322). The connector (323) is mounted securely on the chair ends of the pivoting rods (311). The seat (321) is mounted on the connector (323) and has a pair of posterior slits (328). The posterior slits (328) are formed longitudinally through the seat (321) and each posterior slit (328) may have a lip formed longitudinally in the slit (328). The backrest (322) is mounted adjustably on the connector (323) and has a surface, a pair of dorsum slits (324) and a headrest (326). The dorsum slits (324) are formed longitudinally in the backrest (322) and each dorsum slit (324) may have a lip (325) formed longitudinally in the slit (324). The headrest (326) is mounted on the surface of the backrest (322) has a surface and multiple balls (327) formed on and protruding from the surface of the headrest (326).

The handles (33) are mounted pivotally on the base (13) and each handle (33) has a pivotal end, a bar (331), a guide wheel (332) and may have a grip for improved comfort. The pivotal ends of the handles (33) are respectively mounted pivotally on the ends of the rear connection rod (15). The bars (331) are mounted on the handles (33), align respectively with guide slots (35) and the bars (331) of the handles (33) may be formed as one bar (331). The guide wheels (332) are respectively mounted rotatably on the bars (331) and are mounted in corresponding the guide slots (35).

The massage device (40) has a posterior rod (41), a dorsum rod (42), two pairs of body massaging wheels (43) and at least one massaging resilient element (44).

The posterior rod (41) is mounted pivotally on the base (13), abuts the seat (321) of the chair (32) and has a distal end, a front axle and a mounting protrusion (411). The front axle is attached to the distal end of posterior rod (41) and may be formed or mounted thereon. The mounting protrusion (411) is attached to the posterior rod (41) and may be formed or mounted thereon.

The dorsum rod (42) is mounted pivotally on the base (13), abuts the backrest (322) of the chair (32) and has distal end, a rear axle and a mounting protrusion (421). The rear axle is attached to the dorsum rod (42) and may be formed or mounted thereon. The mounting protrusion (421) is attached to the dorsum rod (42) and may be formed or mounted thereon.

The pairs of the body massaging wheels (43) are rotatably mounted respectively on the front and rear axles and are mounted respectively through the pairs of the posterior and dorsum slits (328, 324) of the seat (321) and the backrest (322). Each body massaging wheel (43) has an annular surface, multiple massage protrusions (432) and may have two annular edges and two grooves. The massage protrusions (432) are formed on the annular surface of the body massaging wheels (43). The grooves are formed around the annular edges of the body massaging wheels (43), to abut an inner rim of one of the posterior and dorsum slits (328, 324) to prevent the body massaging wheel (43) from extending out of the chair (32).

The at least one massaging resilient element (44) is mounted between the posterior rod (41) and the dorsum rod (42), may be mounted on the mounting protrusions (411, 421) of the posterior and dorsum rods (41, 42), to press the posterior and dorsum rods (41, 42) against the chair (32).

The resilient elements (36, 44) may be resilient belts, torsional springs, gas springs or the like or a combination thereof. Multiple resilient elements (36, 44) may be implemented to adjust resistance and comfort.

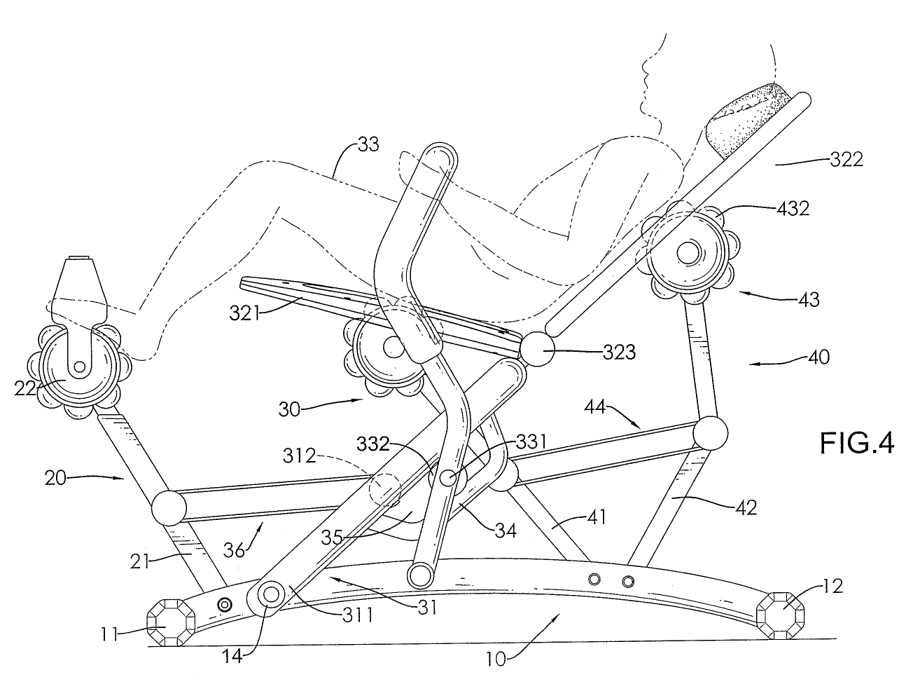

With further reference to FIGS. 3 and 4, when an operator sits on the chair (32), their buttocks, back and head rest respectively against the seat (321) backrest (322) and headrest (326) and are respectively massaged by the foot and body massaging wheels (23, 43) and balls of the headrest. Feet of the operator are secured using the foot-straps (24) then the operator uses their legs and arms to push the chair (32) away from the footrest (20) and controllably return for exercise, while receiving a massaging effect.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A rowing massage machine comprising
a base frame having a base having a front and a rear end; a footrest being mounted on the front end of the base;
a rowing mechanism being mounted on the base frame and having
a pivoting frame having
two pivoting rods being mounted pivotally on the base and each pivoting rod having a frame end and a chair end;
a driven rod being mounted between the pivoting rods; and
two guide rails being formed respectively on the pivoting rods so that each guide rail forms a guide slot; and
at least one resilient element being mounted between the driven rod and the footrest,
a chair being mounted on the pivoting frame and having
a connector being mounted securely on the chair ends of the pivoting rods;
a seat being mounted on the connector and having a pair of posterior slits formed longitudinally through the seat; and
a backrest being mounted on the connector and having a surface; and
a pair of dorsum slits being formed longitudinally in the backrest; and
two handles being mounted pivotally on the base and each handle having
a pivotal end;
a bar being mounted on the handle and aligning with one guide slot; and
a guide wheel being mounted rotatably on the bar and being mounted in one guide slot; and
a massage device having
a posterior rod being mounted pivotally on the base, abutting the seat of the chair and having
a distal end; and
a front axle being attached to the distal end of the posterior rod.
a dorsum rod being mounted pivotally on the base, abutting the backrest of the chair and having
a distal end; and
a rear axle being attached to the distal end of the dorsum rod;
two pairs of body massaging wheels being rotatably mounted respectively on front and rear axles of the posterior and dorsum rods and are mounted respectively through the pairs of the posterior and dorsum slits of the seat and backrest and each body massaging wheel having
an annular surface; and
multiple massaging protrusions being formed on the annular surface of the body massaging wheels; and
at least one massaging resilient element being mounted between the posterior rod and the dorsum rod.

2. The rowing massage machine as claimed in claim 1, wherein the base frame further has
two supporting legs having being respectively attached to the front and rear ends of the base;
a front connection rod being mounted transversely through the base and being adjacent to a corresponding supporting leg and having two ends; and
a rear connection rod being intermediately mounted transversely through the base and having two ends.

3. The rowing massage machine as claimed in claim 2, wherein the footrest further has
a strut being mounted on the base between the supporting leg at the front end of the base and having a distal end;
a foot support being extensibly mounted on the distal end of the strut and having two arms protruding transversely therefrom.;
two foot massaging wheels being respectively mounted rotatably on the arms of the foot support and each foot massaging wheel having an annular surface; and
two foot-straps being respectively mounted adjacent to the massaging wheels and mounted respectively on the arms of the foot support.

4. The rowing massage machine as claimed in claim 3, wherein each foot massaging wheel further has multiple massage protrusions.

5. The rowing massage machine as claimed in claim 3, wherein the foot-straps is hook and loop connectors.

6. The rowing massage machine as claimed in claim 4, wherein the foot-straps is hook and loop connectors.

7. The rowing massage machine as claimed in claim 1, wherein the chair further has a headrest being mounted on the surface of the backrest and having a surface.

8. The rowing massage machine as claimed in claim 2, wherein the chair further has a headrest being mounted on the surface of the backrest and having a surface.

9. The rowing massage machine as claimed in claim 3, wherein the chair further has a headrest being mounted on the surface of the backrest and having a surface.

10. The rowing massage machine as claimed in claim 4, wherein the chair further has a headrest being mounted on the surface of the backrest and having a surface.

11. The rowing massage machine as claimed in claim 5, wherein the chair further has a headrest being mounted on the surface of the backrest and having a surface.

12. The rowing massage machine as claimed in claim 6, wherein the chair further has a headrest being mounted on the surface of the backrest and having a surface.

13. The rowing massage machine as claimed in claim 7, wherein the headrest further has multiple balls being formed on and protruding from the surface of the headrest.

14. The rowing massage machine as claimed in claim 8, wherein the headrest further has multiple balls being formed on and protruding from the surface of the headrest.

15. The rowing massage machine as claimed in claim 9, wherein the headrest further has multiple balls being formed on and protruding from the surface of the headrest.

16. The rowing massage machine as claimed in claim 10, wherein the headrest further has multiple balls being formed on and protruding from the surface of the headrest.

17. The rowing massage machine as claimed in claim 11, wherein the headrest further has multiple balls being formed on and protruding from the surface of the headrest.

18. The rowing massage machine as claimed in claim 12, wherein the headrest further has multiple balls being formed on and protruding from the surface of the headrest.
